(19) United States
(12) Patent Application Publication
(10) Pub. No.: US 2024/0145834 A1
(43) Pub. Date: May 2, 2024

(54) BATTERY MODULE WITH OVERMOLDED BUSBAR

(71) Applicant: Atieva, Inc., Newark, CA (US)

(72) Inventors: James Hawkins, Fremont, CA (US); Pablo Ramaswamy, Newark, CA (US); Eric Magnus Bach, Newark, CA (US); Mehdi Golozar, San Francisco, CA (US)

(21) Appl. No.: 18/547,103

(22) PCT Filed: Feb. 18, 2022
(86) PCT No.: PCT/US2022/070724

§ 371 Date: Aug. 18, 2023

Related U.S. Application Data
(60) Provisional application No. 63/200,166, filed on Feb. 18, 2021.

(51) Int. Cl. H01M 50/227; H01M 10/6554; H01M 50/213; H01M 50/507; H01M 50/547; H01M 10/643; H01M 50/522

(52) U.S. Cl. CPC H01M 50/227; H01M 10/6554; H01M 50/213; H01M 50/507; H01M 50/547; H01M 10/643; H01M 50/522; H01M 2220/20

(57) ABSTRACT

A battery module comprises: electrochemical cells arranged side by side in an array of multiple rows and columns, the electrochemical cells including terminals that comprise a first terminal at respective first ends of the electrochemical cells and at least portions of second terminals at the respective first ends; a housing that holds the electrochemical cells, the housing formed by a molding process with a polymer material; and a planar busbar extending along the terminals throughout the array, the planar busbar joined to the housing by an overmolding operation during the molding process without an adhesive between the planar busbar and the housing.

### CROSS-REFERENCE TO RELATED APPLICATION

This application claims priority to U.S. Patent Application No. 63/200,166, filed on Feb. 18, 2021, and entitled “BATTERY MODULE WITH OVERMOLDED BUSBAR,” the disclosure of which is incorporated by reference herein in its entirety.

### TECHNICAL FIELD

This document relates to a battery module with an overmolded busbar.

### BACKGROUND

In recent years, the world's transportation has begun a transition away from powertrains primarily driven by fossil fuels and toward more sustainable energy sources, chiefly among them electric motors powered by on-board energy storages. In order to make these new modes of transportation available to larger segments of population, vehicle makers are striving to reduce the cost of manufacturing, including the cost of assembling battery packs to power electric motors.

### SUMMARY

In a first aspect, a battery module comprises: electrochemical cells arranged side by side in an array of multiple rows and columns, the electrochemical cells including terminals that comprise a first terminal at respective first ends of the electrochemical cells and at least portions of second terminals at the respective first ends; a housing that holds the electrochemical cells, the housing formed by a molding process with a polymer material; and a planar busbar extending along the terminals throughout the array, the planar busbar joined to the housing by an overmolding operation during the molding process without an adhesive between the planar busbar and the housing.

Implementations can include any or all of the following features. The planar busbar comprises aluminum and the polymer material comprises polycarbonate. The polymer material further comprises glass strands within in the polycarbonate. The housing has an essentially rectilinear shape including four side walls that face each other pairwise, and a first end wall perpendicularly adjoining each of the four side walls at a first end of the rectilinear shape, wherein the housing does not have a second end wall facing the first end wall at a second end of the rectilinear shape opposite the first end. The planar busbar comprises coplanar interleaved fingers. The first end wall has openings between at least some of the coplanar interleaved fingers. The battery module further comprises a conductive bond extending through at least one of the openings, the conductive bond connecting at least one of the terminals to at least one of the coplanar interleaved fingers. The array of the electrochemical cells has six sides, and wherein the housing holds the electrochemical cells by enclosing five sides of the six sides of the array. The battery module further comprises a cooling plate abutting respective second ends of the electrochemical cells at the sixth side of the array, the second ends opposite the first ends of the electrochemical cells. The planar busbar comprises coplanar interleaved fingers. The housing is configured so that the planar busbar is exposed only in a direction facing away from the terminals of the electrochemical cells. The molding process forms a foot on an outside of the housing, the foot including an indicium corresponding to a type of the housing, and a poka-yoke pin configured for mounting of the battery module. The foot is further provided with a compression limiter configured for mounting of the battery module. The battery module further comprises end busbars electrically connected to the planar busbar. The battery module includes multiple planar busbars extending along the terminals throughout the array, the multiple planar busbars joined to the housing by the overmolding operation.

In a second aspect, a method of manufacturing a battery module comprises: molding, with a polymer material, a housing to hold electrochemical cells of the battery module, wherein molding the housing includes joining a planar busbar to the housing by overmolding the planar busbar with the polymer material without placing an adhesive between the planar busbar and the housing; placing the electrochemical cells inside the housing, wherein the electrochemical cells are arranged side by side in an array of multiple rows and columns, the electrochemical cells including terminals that comprise a first terminal at respective first ends of the electrochemical cells and at least portions of second terminals at the respective first ends; and forming conductive bonds between the terminals and the busbar.

Implementations can include any or all of the following features. The busbar comprises aluminum and the polymer material comprises polycarbonate. The housing is molded into an essentially rectilinear shape including four side walls that face each other pairwise, and a first end wall perpendicularly adjoining each of the four side walls at a first end of the rectilinear shape, wherein the housing does not have a second end wall facing the first end wall at a second end of the rectilinear shape opposite the first end. The array of the electrochemical cells has six sides, and wherein the housing holds the electrochemical cells by enclosing five sides of the six sides of the array, the method further comprising mounting a cooling plate to the housing so the cooling plate abuts respective second ends of the electrochemical cells at the sixth side of the array, the second ends opposite the first ends of the electrochemical cells. The method further comprises plasma treating the planar busbar before overmolding the planar busbar with the polymer material.

### BRIEF DESCRIPTION OF DRAWINGS

FIG. 1 shows an example of a battery module.

FIG. 2 shows an example of an exploded view of the battery module of FIG. 1.

FIG. 3 shows an example of the housing of the battery module of FIG. 1.

FIG. 4 shows another view of the housing of FIG. 3.

FIG. 5 schematically shows an example of a method of manufacturing a battery module.

FIG. 6 shows a flowchart with an example of a method of manufacturing a battery module.

FIGS. 7A-7D schematically shows a molding process that includes an overmolding operation.

FIG. 8 shows an example of an array of electrochemical cells.

FIG. 9 shows an example of the housing of FIG. 3 holding the array of the electrochemical cells of FIG. 8.

FIGS. 10A-10B show examples of end busbars that can be used with the housing of FIG. 3.

FIGS. 11-12 show examples of feet that can be provided on the housing of FIG. 3.

FIGS. 13-14 show examples of the planar busbar of the housing of FIG. 3 having coplanar interleaved fingers and conductive bonds between terminals of electrochemical cells and the planar busbar.

FIG. 15 shows an example of multiple instances of the battery module of FIG. 1 for being assembled in a battery pack.

Like reference symbols in the various drawings indicate like elements.

### DETAILED DESCRIPTION

This document describes examples of systems and techniques for manufacturing a battery module using a housing to which a busbar is attached by overmolding the busbar with a polymer material. Such approaches can eliminate the need for applying an adhesive between the busbar and the housing, and thereby reduce manufacturing cost and complexity by eliminating material requirements and omitting multiple operations during assembly. As another example, a housing can be molded into a single unit that is configured to hold an array of electrochemical cells, thereby further reducing the number of manufacturing operations and possibly reducing component weight as well. Either or both of the above approaches can reduce the takt time of the production, meaning the time required to produce parts divided by the number of parts demanded in the time interval, and/or can reduce the scrap rate, which is the percentage of material taken into the manufacturing process that is scrapped.

Examples herein refer to a battery module, which is an individual component configured for holding and managing multiple electrochemical cells during charging, storage, and use. The battery module can be intended as the sole power source for one or more loads (e.g., electric motors), or more than one battery module of the same or different type can be used. Two or more battery modules can be implemented in a system separately or as part of a larger energy storage unit. For example, a battery pack can include two or more battery modules of the same or different type. A battery module can include control circuitry for managing the charging, storage, and/or use of electrical energy in the electrochemical cells, or the battery module can be controlled by an external component. For example, a battery management system can be implemented on one or more circuit boards (e.g., a printed circuit board).

Examples herein refer to electrochemical cells. An electrochemical cells can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrolytic cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples herein refer to molding, which is a process of forming a liquid or pliable material into a shape using a mold. Injection molding is a type of molding process where molten material is injected into the mold cavity. Overmolding refers to a molding operation where one or more parts are first placed inside the mold, and thereafter the molten material is introduced into the mold. This allows the molten material to be brought into contact with the part during the molding process so the part becomes joined to the finished molded component.

Examples herein refer to molding with a polymer material, which is a thermoplastic or thermosetting substance suitable for molding. The polymer material will be selected with properties such that the resulting component has suitable characteristics for the intended use. For example, a polymer material being molded into a housing to hold electrochemical cells should in its finished state have appropriate strength and stiffness considering the weight of the cells and its application, and also appropriate thermal and electrical properties in view of the charging, storage, and/or use of the electrochemical cells. Polycarbonate is an example of a polymer that can be molded into a housing for electrochemical cells. A polycarbonate material contains carbonate groups and is typically a good insulator and is resistant to heat and flames. One or more other materials can be added to the polymer material before the molding to change one or more of its properties. In some implementations, a polycarbonate material can have one or more additives. For example, strands of glass and/or another material can be added to polycarbonate or another polymer material.

Examples herein refer to plasma treating a component before overmolding the component, which is a process that serves to remove contaminants from the surface of the component and/or otherwise prepare the component for being overmolded. Plasma treatment involves applying a plasma of one or more working fluids to the surface of the component. Air, an inert gas (e.g., argon), or hydrogen, are just a few examples of working fluids that can be used. Plasma can be generated by any suitable technique, including, but not limited to, by applying an electric potential across the working fluid to separate electrons from the molecules/atoms, thereby generating ions. A plasma source can then apply the plasma (e.g., in form of a beam) to the surface in one or more iterations.

Examples herein refer to a busbar, and a battery module can have at least one busbar. The busbar is electrically conductive and is used for conducting electricity to the electrochemical cells when charging, or from the cells when discharging. The busbar is made of an electrically conductive material (e.g., metal) and has suitable dimensions considering the characteristics of the electrochemical cells and the intended use. In some implementations, the busbar comprises aluminum (e.g., an aluminum alloy). A busbar can be planar (e.g., flat) or can have one or more bends, depending on the shape and intended use of the battery module.

Examples herein refer to a top or a bottom. These and similar expressions identify things or aspects in a relative way based on an express or arbitrary notion of perspective. That is, these terms are illustrative only, used for purposes of explanation, and do not necessarily indicate the only possible position, direction, and so on.

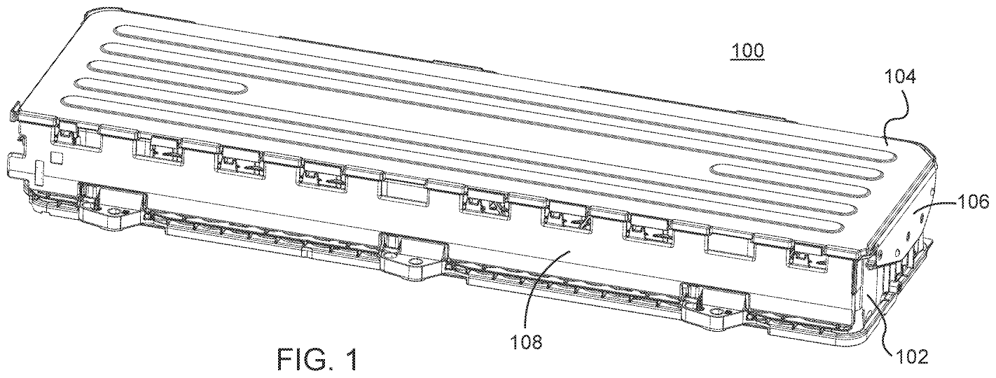

FIG. 1 shows an example of a battery module 100. The battery module 100 and or any of its components can be used with one or more other examples described elsewhere herein. The battery module 100 includes a housing 102. In some implementations, the housing 102 is a molded structure with a shape that defines a space (e.g., one or more cavities) for holding electrochemical cells (not shown). The battery module 100 can include a lid 104. In some implementations, the lid 104 can cover one or more electrical components of the battery module 100. For example, the lid 104 can cover one or more busbars and/or one or more bonds between a busbar and a cell. Here, an end busbar 106 is shown mounted to the housing 102 at an end of the battery module 100. Another busbar (not shown) may be joined to the housing 102 by being overmolded during a process of molding the housing 102, for example as will be described below. The battery module 100 includes at least one control circuitry 108. For example, the control circuitry 108 can include a battery management system formed on a printed circuit board.

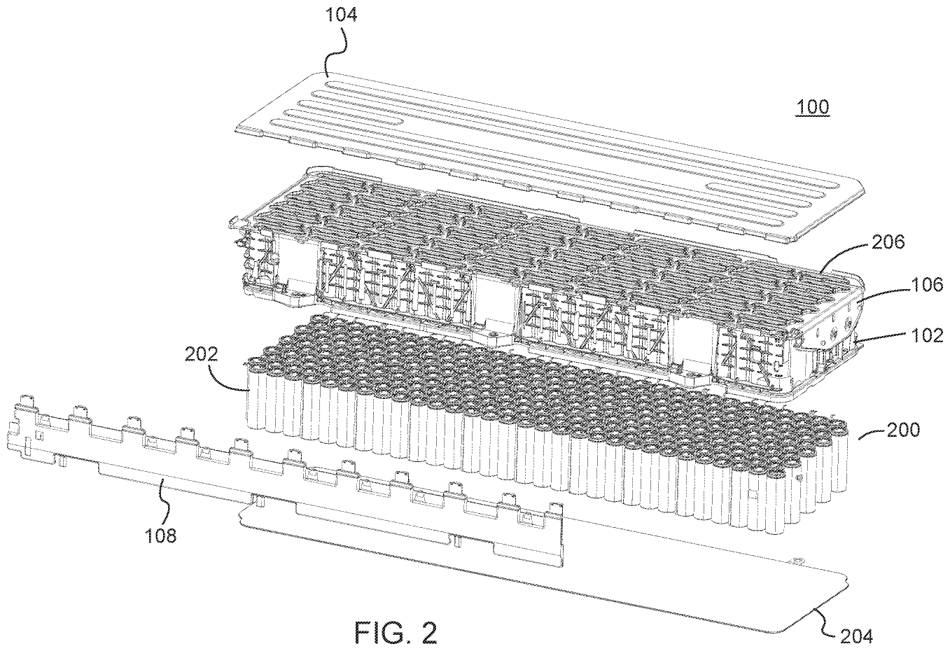

FIG. 2 shows an example of an exploded view of the battery module 100 of FIG. 1. Here, the battery module 100 includes the housing 102 and the lid 104 and the control circuitry 108, and an array 200 of electrochemical cells 202, and a cooling plate 204. The array 200 has the electrochemical cells 202 arranged side by side in multiple rows and columns. The rows and columns can be defined according to any arbitrary direction, including, but not limited to, such that a column runs along the control circuitry 108 and that a row is perpendicular to the control circuitry 108. Any of multiple numbers of the electrochemical cells 202 can be in each row and column. In some implementations, each row can hold about 2-10 cells, such as about 5 cells. In some implementations, each column can hold about 10-50 cells, such as about 30 cells. Other numbers of cells in each row and/or column can be used.

Removal of the lid 104 here shows the housing 102 having a planar busbar 206 adjacent to the end busbar 106. The planar busbar 206 is joined to the housing 102 by an overmolding operation during the process where the housing 102 is molded using a polymer material. As such, no adhesive is present between the planar busbar 206 and the housing 102. The housing 102 can be molded as a single-piece component of polymer material, including the operation of overmolding the planar busbar 206. This reduces the part count for the manufacturing process, and can eliminate the time and cost associated with molding the housing 102 as individual pieces, and the time and cost of assembling those pieces into a single unit.

The planar busbar 206 extends along the terminals of the electrochemical cells 202, and bonds (not shown) will be created between the planar busbar 206 and the terminals. Each of the electrochemical cells 202 has first and second terminals, such as a positive and a negative terminal. Both of the first and second terminals may be exposed (at least in part) at an end of the electrochemical cell 202 that is situated near the planar busbar 206. In some implementations, the first terminal may be exposed only at that end of the electrochemical cell 202, and the second terminal may be exposed both at that end and elsewhere on the electrochemical cell 202, such that at least a portion of the second terminal exists at the end of the electrochemical cell 202.

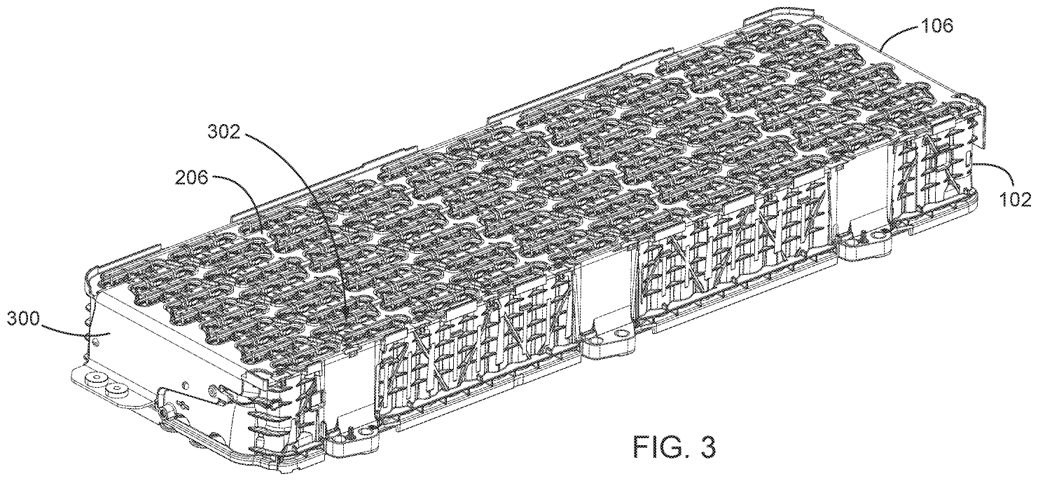

FIG. 3 shows an example of the housing 102 of the battery module 100 of FIG. 1. The housing 102 has the planar busbar 206 and the end busbar 106, and also an end busbar 300 at an opposite end of the housing 102 from the end busbar 106. The end busbar 300 is electrically coupled to the planar busbar 206. The housing 102 has openings 302 into its interior. In some implementations, one or more bonds to terminals of the electrochemical cells can be formed through at least one of the openings 302. The planar busbar 206 is here overmolded by the polymer material of the housing 102 in such a way that the exposed portions of the planar busbar 206 (that is, the portions not covered by the polymer material) face in a direction away from the terminals of the electrochemical cells.

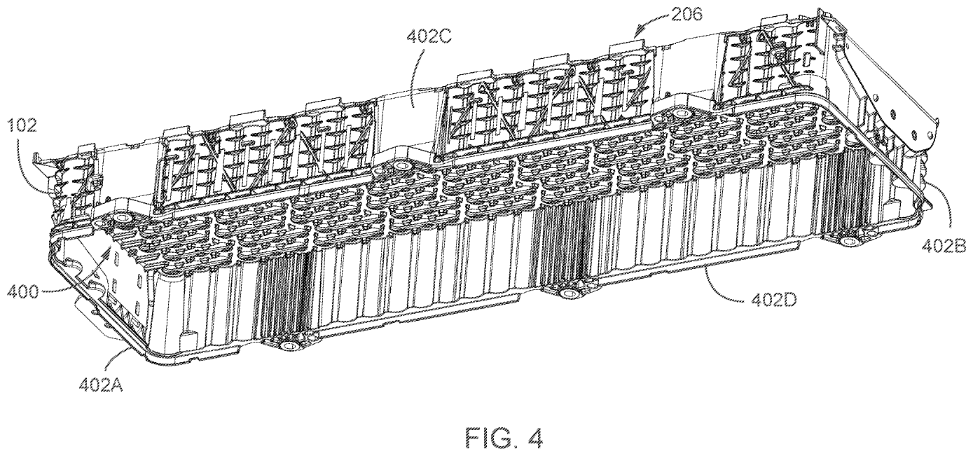

FIG. 4 shows another view of the housing 102 of FIG. 3. In some implementations, the housing 102 has substantially a prismatic shape, such as an essentially rectilinear shape. The housing 102 can have an interior 400 that is configured for holding electrochemical cells (e.g., the array 200 of FIG. 2). Here, the housing 102 has four side walls 402A-402D. In some implementations, the side walls 402A-402D face each other pairwise. For example, the side walls 402A and 402B here face each other. As another example, the side walls 402C and 402D here face each other. The planar busbar 206 and the polymer material that overmolds it can collectively be considered to constitute an end wall of the housing 102. In some implementations, such an end wall can perpendicularly adjoin each of the side walls 402A-402D. By contrast, the opening to the interior 400, which here faces and is opposite to the end wall of the planar busbar 206 and the polymer material, may not have an end wall that is molded as part of the housing 102. For example, the opening may instead be covered by another component, including, but not limited to, the cooling plate 204 (FIG. 2).

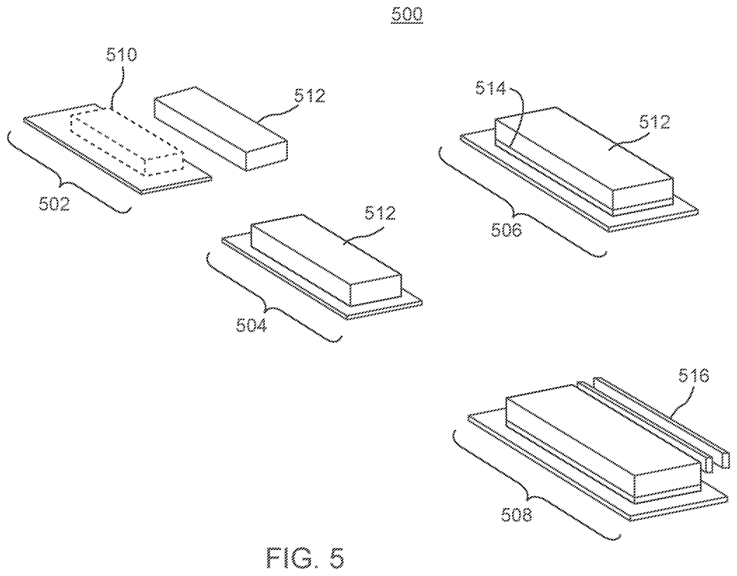

FIG. 5 schematically shows an example of a method 500 of manufacturing a battery module. The method 500 can be performed together with one or more other examples described elsewhere herein. The method 500 here includes operations 502, 504, 506, and 508. Two or more of the operations 502-508 can be performed in a different order unless otherwise indicated. More or fewer operations can be performed.

In operation 502, a fixture 510 for electrochemical cells can be provided and populated with the cells. The fixture 510 facilitates arrangement of the electrochemical cells side by side in an array of multiple rows and columns. The electrochemical cells and/or the array thereof can be similar or identical to the array 200 of the electrochemical cells 202 in FIG. 2. The cells can be placed in the fixture 510 manually or using a robotic operation, for example. A housing 512 configured to hold the electrochemical cells is formed by a molding process with a polymer material. The housing 512 can be similar or identical to the housing 102 in FIG. 2.

In operation 504, adhesive can be dispensed at the inside of the housing 512, and the housing 512 and/or the fixture 510 can be positioned so that the housing 512 holds the electrochemical cells in its interior. For example, the housing 512 can be lowered onto the fixture 510 so as to cover the cells from above. The housing 512 and/or the electrochemical cells can be moved relative to each other by manual operation or using a robot, for example. In some implementations, one or more additional aspects of assembly is performed regarding the housing 512. For example, one or more end busbars can be attached to the housing 512. As another example, after the housing 512 is in place, one or more conductive bonds can be formed between terminals of the electrochemical cells and a planar busbar of the housing 512.

In operation 506, adhesive can be dispensed on a cooling plate 514. The cooling plate 514 and/or the housing 512 can be positioned so that the cooling plate 514 abuts an end of the housing 512 where the electrochemical cells are not covered by the housing 512. For example, the cooling plate 514 can be affixed to ends (e.g., bottom ends) of the electrochemical cells opposite the ends (e,g, top ends) facing the planar busbar of the housing 512. In some implementations, one or more additional aspects of assembly is performed regarding the housing 512. For example, one or more conductive bonds can be formed between terminals of the electrochemical cells and a planar busbar of the housing 512.

In operation 508, at least one control circuitry 516 can be provided to the housing 512. The control circuitry 516 can be similar or identical to the control circuitry 108 in FIG. 1. In some implementations, one or more additional aspects of assembly is performed regarding the housing 512. For example, one or more conductive bonds can be formed between terminals of the electrochemical cells and a planar busbar of the housing 512.

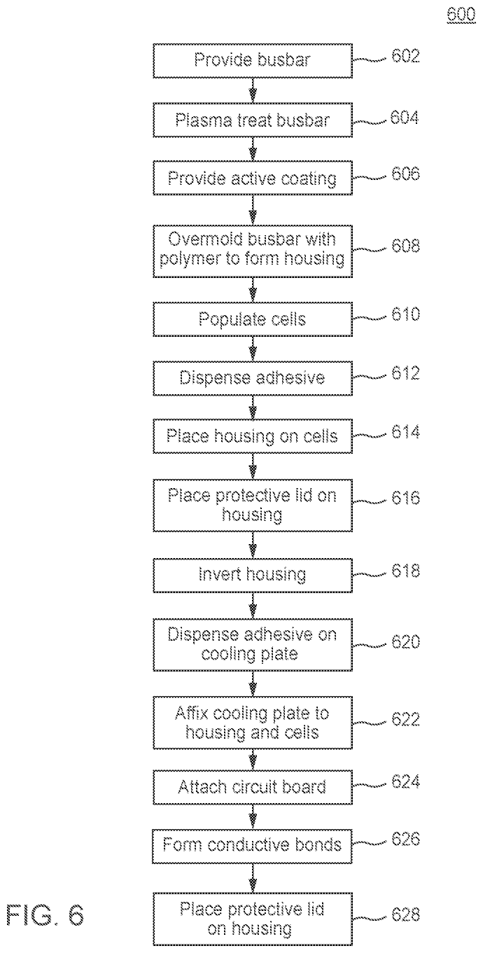

FIG. 6 shows a flowchart with an example of a method 600 of manufacturing a battery module. The method 600 can be performed together with one or more other examples described elsewhere herein. Two or more of the operations can be performed in a different order unless otherwise indicated. More or fewer operations can be performed.

In operation 602, a busbar can be provided. In some implementations, the busbar is a planar busbar. For example, the planar busbar 206 in FIG. 3 can be stamped from stock metal, including, but not limited to, from a sheet of aluminum or an aluminum alloy.

In operation 604, the busbar can be plasma treated. In some implementations, a plasma of an ionized working fluid can be directed at, or otherwise be brought into contact with, the busbar.

In operation 606, one or more additional operations can be performed to treat the busbar. For example, a functionalizing operation can be performed in which the busbar is subjected, after being exposed to plasma, to one or more chemicals, compounds, or other agents that serve to activate the busbar surface for a subsequent overmolding operation. As such, the busbar can be provided with an active coating that is conducive to bonding against polymer material of a molding operation.

In operation 608, the busbar can be overmolded with polymer material as part of a molding process for a housing. In some implementations, the planar busbar 206 can be overmolded in forming the housing 102 in FIG. 3. For example, injection molding can be performed.

In operation 610, cells can be populated in a fixture. For example, the electrochemical cells 202 (FIG. 2) can be populated into the fixture 510 (FIG. 5).

In operation 612, adhesive can be dispensed at an inside of the housing. For example, adhesive can be placed on the inside face of one or more of the side walls 402A-402D (FIG. 4).

In operation 614, the electrochemical cells can be positioned in an interior of the housing. For example, the housing 512 (FIG. 5) can be placed onto the electrochemical cells from above.

In operation 616, a protective lid can be placed on the housing. For example, the lid 104 can be placed on the housing 102 (FIG. 2).

In operation 618, the housing as assembled so far can be inverted. The inversion can be performed by manual operation or using a robot, for example. In some implementations, the inversion results in a non-covered side of the array of electrochemical cells being oriented in a particular direction. For example, the inversion can result in the bottoms of the electrochemical cells facing upward.

In operation 620, adhesive can be dispensed on a cooling plate. For example, adhesive can be placed on the cooling plate 204 (FIG. 2).

In operation 622, the cooling plate can be affixed to at least the electrochemical cells by way of the adhesive. For example, the cooling plate is affixed to at least bottoms of the electrochemical cells that are exposed by an open end of the housing.

In operation 624, one or more control circuits can be attached to the battery module. In some implementations, the control circuit includes a circuit board and can be configured for managing the electrochemical cells with regard to charging, storage, and discharge of electric energy.

In operation 626, one or more conductive bonds can be formed between the planar busbar of the housing and terminals of the electrochemical cells. The planar busbar, or planar busbars, of the housing can be exposed (free from polymer material) in one or more directions, including, but not limited to, in a direction facing away from the cell terminals. In some implementations, openings can be provided in the housing to facilitate bond formation to the terminals. For example, the housing can have openings between coplanar interleaved fingers of the busbar(s).

In operation 628, a protective lid can be placed on the housing. In some implementations, the lid 104 can be placed on the housing 102 (FIG. 2). For example, the lid may be put on the housing for protection in the inversion of the operation 618, and may thereafter be removed to facilitate formation of the conductive bonds in the operation 626.

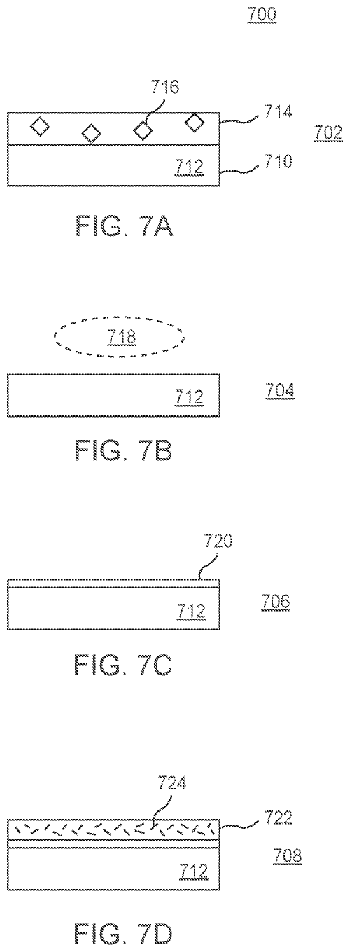

FIGS. 7A-7D schematically shows a molding process 700 that includes an overmolding operation. The molding process 700 can be performed together with one or more other examples described elsewhere herein. The molding process 700 here includes operations 702, 704, 706, and 708. Two or more of the operations 702-708 can be performed in a different order unless otherwise indicated. More or fewer operations can be performed.

In operation 702, a planar busbar 710 is provided. The planar busbar 710 can represent, and be similar or identical to, one or more instances of the planar busbar 206 (FIG. 2). The planar busbar 710 includes a layer 712 of conductive material (e.g., metal) that is currently covered by a layer 714 including at least one substance 716. For example, the substance 716 can include a contaminant and/or an oxide (e.g., a metal oxide).

In operation 704, the planar busbar 710 is subjected to a plasma 718. In some implementations, the plasma 718 removes the layer 714 completely or partially. For example, the operation 704 may expose metal of the layer 712 that had previously been covered.

In operation 706, a layer 720 can be formed on the layer 712. In some implementations, the layer 720 serves to render the planar busbar 710 active with regard to being overmolded by a polymer material. For example, the layer 720 can be generated by subjecting the planar busbar 710 to one or more functionalizing chemicals, compounds, or other agents.

In operation 708, the planar busbar 710 is overmolded with a polymer material to generate a polymer layer 722. The polymer layer 722 here covers an entire side of the planar busbar 710 for illustrative purposes. In some implementations, one or more areas of the planar busbar 710 is free of the polymer layer 722.

One or more other materials can be provided in the material of the polymer layer 722. An additive can be chosen to give the polymer layer 722 one or more desired characteristics. In some implementations, the polymer layer 722 can include glass strands 724. For example, the percentage of the glass strands relative to the amount of polymer material can be selected depending on the desired characteristic(s).

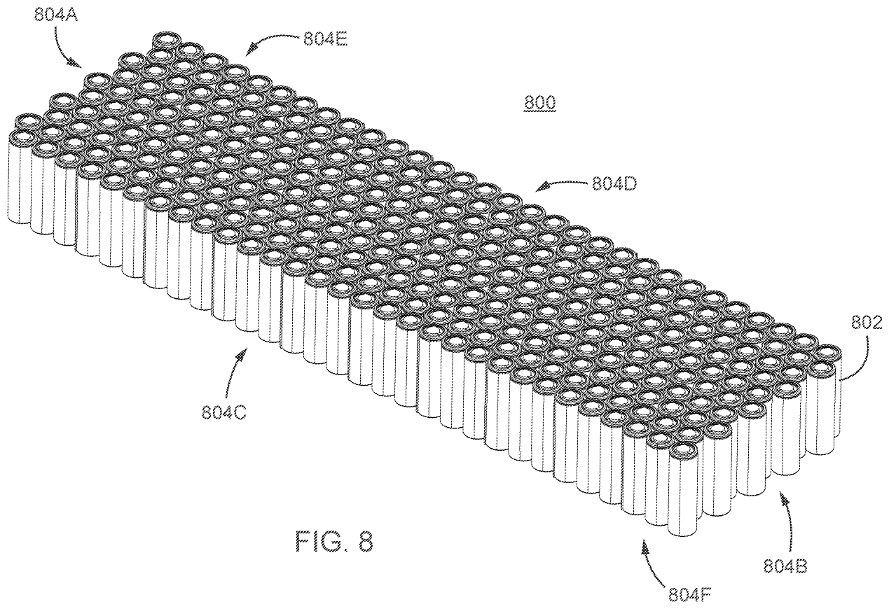

FIG. 8 shows an example of an array 800 of electrochemical cells 802. The array 800 and/or the electrochemical cells 802 can be used with one or more other examples described elsewhere herein. The electrochemical cells 802 can be placed in a fixture, such as the fixture 510 in FIG. 5, in order to arrange them side by side in the array 800. For example, the electrochemical cells 802 can be placed in a hexagonal close packed configuration where each inner cell of the array 800 (i.e., all cells except the cells that face outward on the sides of the array 800) is abutted by six other cells.

The array 800 can have any number of rows of the electrochemical cells 802, and any number of columns of the electrochemical cells 802. For example, each column of the array 800 here has 30 cells. As another example, each row of the array 800 here has 5 cells. Other numbers of cells can be used in the columns and/or the rows.

The array 800 here has six sides formed by the electrochemical cells 802. Sides 804A-804D of the array 800 are formed by lateral surfaces of the electrochemical cells 802. For example, the side 804A is here opposite to the side 804B. As another example, the side 804C is here opposite to the side 804D. A side 804E of the array 800 is here formed by at least part of the terminals of the electrochemical cells 802. For example, a first terminal and at least a portion of a second terminal of each cell can be located at ends of the electrochemical cells 802 so as to form the side 804E. A side 804F of the array 800 is here opposite the side 804E and is formed by respective ends of the electrochemical cells 802 that are opposite to the ends forming the side 804E.

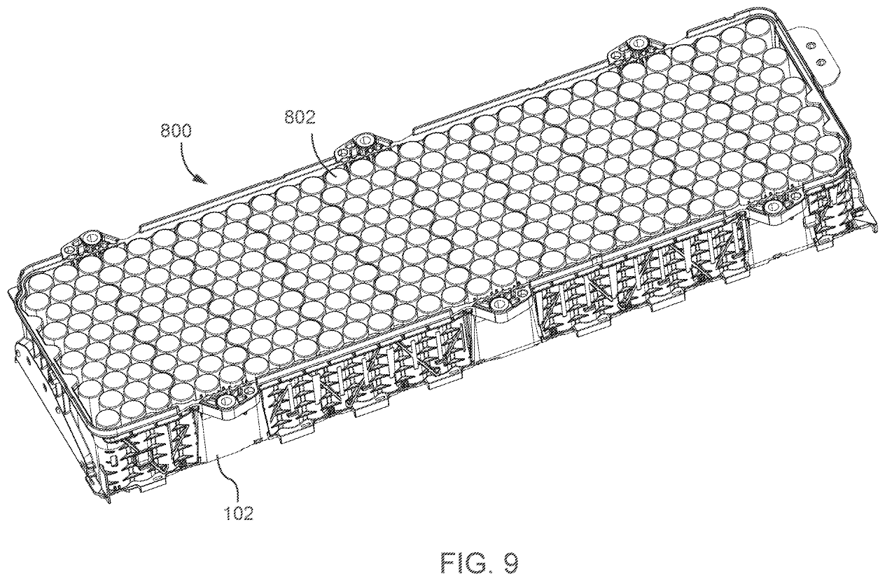

FIG. 9 shows an example of the housing 102 of FIG. 3 holding the array 800 of the electrochemical cells of FIG. 8. The housing 102 can hold the electrochemical cells 802 by enclosing five of the six sides of the array 800. Reference will briefly be made also to FIGS. 4 and 8. For example, the side walls 402A-402D of the housing 102 can enclose the sides 804A-804D, respectively, of the array 800. As another example, the side wall of the housing 102 having the planar busbar 206 can enclose the side 804E of the housing 102. By contrast, the side 804F of the array 800 may not be enclosed by the housing 102. For example, the cooling plate 204 (FIG. 2) can enclose the side 804F.

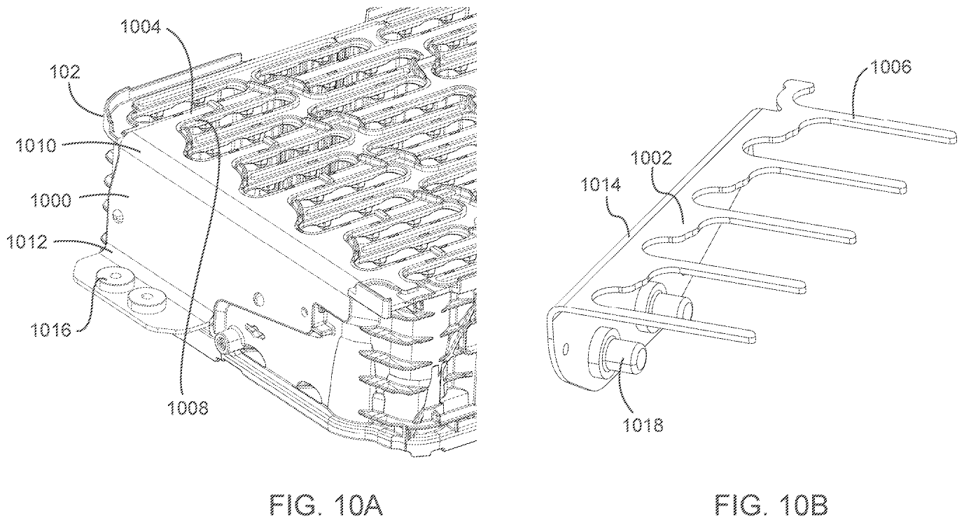

FIGS. 10A-10B show examples of end busbars 1000 and 1002 that can be used with the housing 102 of FIG. 3. The end busbar 1000 is shown mounted to the housing 102 for illustrative purposes only. The end busbar 1000 and/or 1002 can be used with one or more other examples described elsewhere herein. The end busbars 1000 and 1002 are made of the same or a different conductive material. For example, aluminum or an aluminum alloy can be used. The sizing of the end busbars 1000 and 1002 can be determined in view of the implementation and intended use, taking into account one or more factors including, but not limited to, weight, the space available for making electrical connections to and from the battery module, or the current carrying capacity of a particular configuration of the end busbars 1000 or 1002.

The end busbar 1000 has coplanar fingers 1004 and the end busbar 1002 has coplanar fingers 1006. The coplanar fingers 1004 and 1006 can be used when forming a bond to the terminal of one or more electrochemical cells. In some implementations, the coplanar fingers 1004 and 1006 can be configured for extending on respective sides of openings in an end or side of a housing, such as an opening 1008 in the housing 102. For example, the spacing between individual ones of the coplanar fingers 1004 and/or 1006 can essentially correspond to the spacing between coplanar fingers that are part of a planar busbar that has been overmolded into a housing.

An end busbar can have at least one bend. The end busbar 1000 has a bend 1010 proximate the coplanar fingers 1004, and a bend closer to another end of the end busbar 1000. The end busbar 1002 has a bend 1012 proximate the coplanar fingers 1006. As such, the end busbar 1000 positions at least one electrical terminal 1016 so as to face in a common direction with the terminals of the electrochemical cells of the housing 102. By analogy, the end busbar 1002 positions at least one electrical terminal 1018 so as to face in a perpendicular direction to the terminals of the electrochemical cells of the corresponding housing. Other approaches can be used.

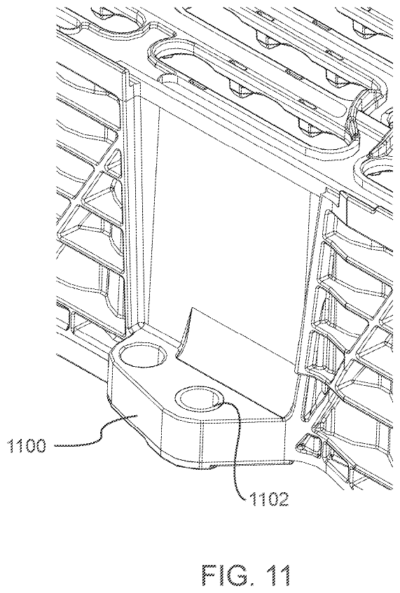

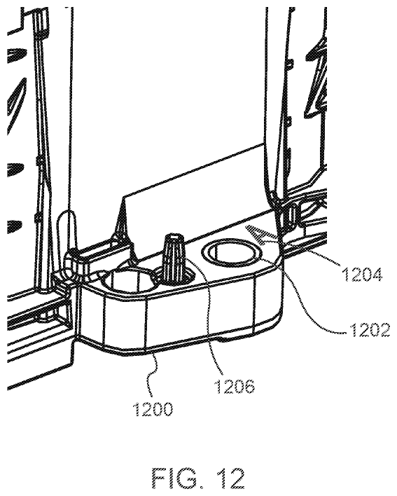

FIGS. 11-12 show examples of feet 1100 and 1200 that can be provided on the housing 102 of FIG. 3. The feet 1100 and/or 1200 can be used with one or more other examples described elsewhere herein. The feet 1100 and 1200 can be formed on the outside of the housing by the molding operation that creates the corresponding housing.

The foot 1100 here includes a compression limiter 1102, and the foot 1200 here includes a compression limiter 1202. The compression limiter 1102 and/or 1202 can serve to maintain the structural integrity where the corresponding housing is mounted to another component. For example, when the battery module is bolted to the wall of a battery pack, the compression limiter 1102 and/or 1202 can protect the polymer material of the housing from the compression load of the bolts being tightened.

More than one type of battery module can be manufactured. In some implementations, multiple types of battery modules can be included in the same system, such as in a battery pack. For example, the battery pack can be designed to require that the module end with the end busbar 1000 is positioned inward (e.g., toward a spine or center) in the pack rather than outward (e.g., at the edge of the pack). Previous approaches may have used different end busbars to differentiate between the different types of battery module, which meant additional busbar parts were part of the design and assembly. In some implementations according to the present disclosure, however, such differences between types of battery modules can be accounted for or embraced by the molded housing. As such, the extra busbar parts can be omitted.

Instead, an insert can be placed in the (injection) molding tool corresponding to, say, the foot 1200. The tool can cause the molding process to provide an indicium 1204 (here the letter A) corresponding to a type of the housing, and a poka-yoke pin 1206 configured for mounting of the battery module. The poka-yoke pin 1206 extends from the foot 1200 and is configured to prevent installation of the battery module in any other way than the intended orientation. The battery module having the foot 1100 can have a corresponding indicium, such as the letter B. Now one determines the type of battery module being manufactured (e.g., A or B) in the molding tool, and the extra end busbars need not be produced or taken into account in the manufacturing process.

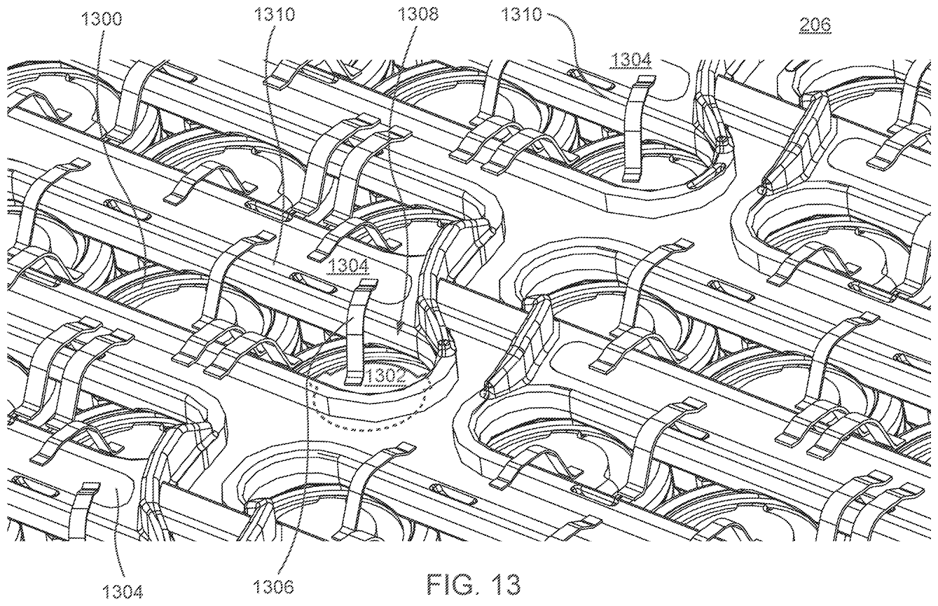

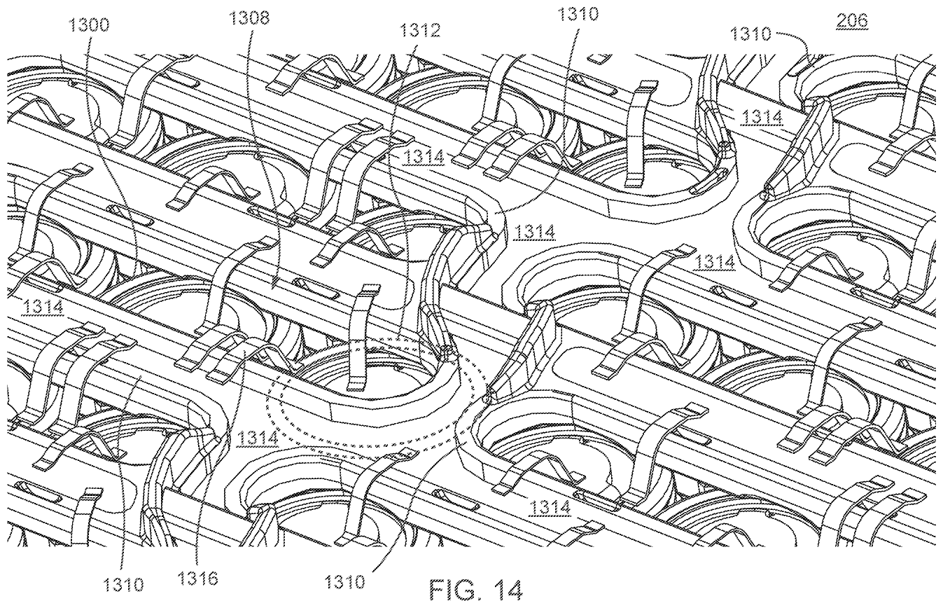

FIGS. 13-14 show examples of the planar busbar 206 of the housing of FIG. 3 having coplanar interleaved fingers and conductive bonds between terminals of electrochemical cells 1300 and the planar busbar 206. The planar busbar 206 is part of an end wall of the housing of the battery module, the end wall having been formed by overmolding the planar busbar 206 with polymer material. Only a portion of the end wall is shown for simplicity.

Each of the electrochemical cells 1300 includes a terminal 1302 that is positioned in the center of one end of the cylindrical shape of the electrochemical cell 1300. For example, the terminal 1302 can be a positive terminal. The terminal 1302 is connected to a coplanar interleaved finger 1304 of the planar busbar 206 by a conductive bond 1306 (e.g., a conductive wire) that extends through an opening 1308 formed in the process of overmolding the coplanar interleaved finger 1304 with polymer material. Here, polymer material 1310 that has been overmolded on the respective coplanar interleaved fingers 1304 is present near (e.g., and acts as a lining of) each of the openings 1308. For example, the housing of the battery module can be configured so that the coplanar interleaved fingers 1304 are exposed only in a direction facing away from the terminal 1302. In some implementations, through the conductive bonds 1306 the coplanar interleaved finger 1304 can be connected to the positive terminals of at least some of the electrochemical cells 1300.

Each of the electrochemical cells 1300 includes a terminal 1312 that is at least in part positioned around the periphery of one end of the cylindrical shape of the electrochemical cell 1300. For example, the terminal 1312 can be a negative terminal. The terminal 1312 is connected to a coplanar interleaved finger 1314 of the planar busbar 206 by a conductive bond 1316 (e.g., a conductive wire) that extends through the opening 1308. Similar to the example above, the polymer material 1310 that has been overmolded on the respective coplanar interleaved fingers 1314 is present near (e.g., lines) each of the openings 1308. For example, the housing of the battery module can be configured so that the coplanar interleaved fingers 1314 are exposed only in a direction facing away from the terminal 1312. In some implementations, through the conductive bonds 1316 the coplanar interleaved finger 1314 can be connected to the negative terminals of at least some of the electrochemical cells 1300.

The planar busbar 206 can comprise multiple planar busbars. In some implementations, the coplanar interleaved fingers 1304 and the coplanar interleaved fingers 1314 can be part of separate busbars that are planar and that have been overmolded with polymer material.

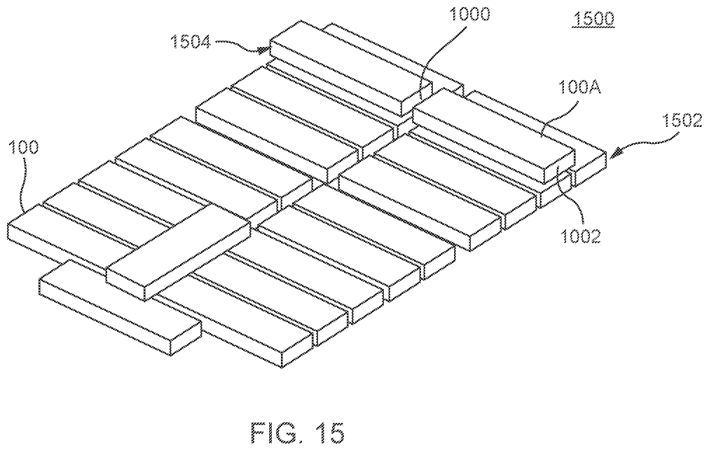

FIG. 15 shows an example of multiple instances of the battery module 100 of FIG. 1 for being assembled in a battery pack 1500. The battery pack 1500 can be used with one or more other examples described elsewhere herein. The housing of the battery pack 1500 has been omitted for purposes of illustration.

The battery modules 100 can be organized in one or more layers in the battery pack 1500. Here, the battery modules 100 are arranged in two layers: a layer 1502 includes 19 of the battery modules 100, and a layer 1504 includes 3 of the battery modules 100.

The battery modules 100 can be oriented in one or more directions within the battery pack 1500. For example, one of the battery modules 100 that is referred to as battery module 100A is here oriented so that its end busbar 1000 is positioned inward (e.g., toward a spine or center) of the battery pack 1500, and so that its end busbar 1002 is positioned outward (e.g., at the edge) of the battery pack 1500. Other approaches can be used. For example, the poka-yoke pin 1206 (FIG. 12) can ensure the proper orientation of the battery modules 100, including the battery module 100A.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A battery module comprising:
electrochemical cells arranged side by side in an array of multiple rows and columns, the electrochemical cells including terminals that comprise a first terminal at respective first ends of the electrochemical cells and at least portions of second terminals at the respective first ends;
a housing that holds the electrochemical cells, the housing formed by a molding process with a polymer material; and
a planar busbar extending along the terminals throughout the array, the planar busbar joined to the housing by an overmolding operation during the molding process without an adhesive between the planar busbar and the housing.

2. The battery module of claim 1, wherein the planar busbar comprises aluminum and the polymer material comprises polycarbonate.

3. The battery module of claim 2, wherein the polymer material further comprises glass strands within in the polycarbonate.

4. The battery module of claim 1, wherein the housing has an essentially rectilinear shape including four side walls that face each other pairwise, and a first end wall perpendicularly adjoining each of the four side walls at a first end of the rectilinear shape, wherein the housing does not have a second end wall facing the first end wall at a second end of the rectilinear shape opposite the first end.

5. The battery module of claim 4, wherein the planar busbar comprises coplanar interleaved fingers.

6. The battery module of claim 5, wherein the first end wall has openings between at least some of the coplanar interleaved fingers.

7. The battery module of claim 6, further comprising a conductive bond extending through at least one of the openings, the conductive bond connecting at least one of the terminals to at least one of the coplanar interleaved fingers.

8. The battery module of claim 1, wherein the array of the electrochemical cells has six sides, and wherein the housing holds the electrochemical cells by enclosing five sides of the six sides of the array.

9. The battery module of claim 8, further comprising a cooling plate abutting respective second ends of the electrochemical cells at the sixth side of the array, the second ends opposite the first ends of the electrochemical cells.

10. The battery module of claim 1, wherein the planar busbar comprises coplanar interleaved fingers.

11. The battery module of claim 1, wherein the housing is configured so that the planar busbar is exposed only in a direction facing away from the terminals of the electrochemical cells.

12. The battery module of claim 1, wherein the molding process forms a foot on an outside of the housing, the foot including an indicium corresponding to a type of the housing, and a poka-yoke pin configured for mounting of the battery module.

13. The battery module of claim 12, wherein the foot is further provided with a compression limiter configured for mounting of the battery module.

14. The battery module of claim 1, further comprising end busbars electrically connected to the planar busbar.

15. The battery module of claim 1, wherein the battery module includes multiple planar busbars extending along the terminals throughout the array, the multiple planar busbars joined to the housing by the overmolding operation.

16. A method of manufacturing a battery module, the method comprising:
molding, with a polymer material, a housing to hold electrochemical cells of the battery module, wherein molding the housing includes joining a planar busbar to the housing by overmolding the planar busbar with the polymer material without placing an adhesive between the planar busbar and the housing;
placing the electrochemical cells inside the housing, wherein the electrochemical cells are arranged side by side in an array of multiple rows and columns, the electrochemical cells including terminals that comprise a first terminal at respective first ends of the electrochemical cells and at least portions of second terminals at the respective first ends; and
forming conductive bonds between the terminals and the busbar.

17. The method of claim 16, wherein the busbar comprises aluminum and the polymer material comprises polycarbonate.

18. The method of claim 16, wherein the housing is molded into an essentially rectilinear shape including four side walls that face each other pairwise, and a first end wall perpendicularly adjoining each of the four side walls at a first end of the rectilinear shape, wherein the housing does not have a second end wall facing the first end wall at a second end of the rectilinear shape opposite the first end.

19. The method of claim 16, wherein the array of the electrochemical cells has six sides, and wherein the housing holds the electrochemical cells by enclosing five sides of the six sides of the array, the method further comprising mounting a cooling plate to the housing so the cooling plate abuts respective second ends of the electrochemical cells at the sixth side of the array, the second ends opposite the first ends of the electrochemical cells.

20. The method of claim 16, further comprising plasma treating the planar busbar before overmolding the planar busbar with the polymer material.
